(19) United States
(12) Patent Application Publication
(10) Pub. No.: US 2017/0018026 A1
(43) Pub. Date: Jan. 19, 2017

(54) AIRCRAFT SERVICE BULLETIN ANALYSIS SYSTEM AND METHOD

(71) Applicant: THE BOEING COMPANY, Chicago, IL (US)

(72) Inventors: Debra Alice Rigdon, Kent, WA (US); Daniel Robert Ryan, Sammamish, WA (US)

(73) Assignee: THE BOEING COMPANY, Chicago, IL (US)

(21) Appl. No.: 14/800,854

(22) Filed: Jul. 16, 2015

(51) Int. Cl. G06Q 40/00

(52) U.S. Cl. CPC G06Q 40/00

(57) ABSTRACT

An aircraft service bulletin analysis system is configured to provide an economic analysis of implementing one or more service bulletins regarding one or more aircraft. The aircraft service bulletin system may include one or more processors configured to retrieve aircraft data and service bulletin data, form a aggregated aircraft data file that includes the aircraft data and the service bulletin data, and generate an economic analysis based on one or more aircraft and implementing one or more service bulletins associated with the aircraft selected by a user.

### FIELD OF THE DISCLOSURE

Embodiments of the present disclosure generally relate to systems and methods for analyzing aircraft service bulletins, and, more particularly, to systems and methods for efficiently determining cost and benefit analyses with respect to service bulletins for one or more aircraft.

### BACKGROUND OF THE DISCLOSURE

A service bulletin is a notice to an airline provider from a manufacturer regarding an improvement, upgrade, and/or the like to a particular system or sub-system of an aircraft owned by the provider. Each service bulletin focuses on a particular issue related to a particular system or sub-system within an aircraft. For example, a service bulletin may provide information regarding an improvement or upgrade to a wheel sub-system within a landing system. In general, a service bulletin identifies a particular issue, potential upgrades, changes, remedies, or the like, and costs associated with remedying the issue.

A mandatory service bulletin may be issued by the Federal Aviation Administration (FAA) and/or a manufacturer and identifies one or more changes, upgrades, remedies, or the like that a provider must implement. In short, a provider has no discretion as to whether or not to comply with a mandatory service bulletin.

In contrast, a non-mandatory service bulletin may be issued by a manufacturer and allows a provider to choose whether or not to implement the service bulletin. For example, a non-mandatory service bulletin may provide information regarding an upgrade that improves fuel economy of an aircraft. The provider may perform an economic analysis to determine the costs and benefits of implementing the service bulletin. If the costs exceed the benefits over a particular time period, the provider typically decides not to implement the service bulletin. If, however, the economic benefits outweigh the costs in the long term, the provider may choose to implement the service bulletin.

As can be appreciated, performing an economic analysis of multiple service bulletins is complex and time-consuming. The economic analysis typically includes evaluation of data from numerous sources. Retrieving and organizing vast amounts of data from multiple sources may prove difficult, if not impossible.

Accordingly, a need exists for a system and method for efficiently organizing service bulletins for aircraft and analyzing information to quickly and accurately assess the economic costs and benefits of implementing service bulletins.

### SUMMARY OF THE DISCLOSURE

Certain embodiments of the present disclosure provide an aircraft service bulletin analysis system that is configured to provide an economic analysis of implementing one or more service bulletins regarding one or more aircraft. The aircraft service bulletin system may include one or more processors that are configured to retrieve aircraft data and service bulletin data, form an aggregated aircraft data file that includes the aircraft data and the service bulletin data, and generate an economic analysis based on one or more aircraft and implementing one or more service bulletins associated with the aircraft selected by a user.

The aircraft data may include general aircraft data retrieved from a general aircraft database that is remote from the aircraft service bulletin analysis system, and specific aircraft data retrieved from a specific aircraft database that is remote from the aircraft service bulletin analysis system. The service bulletin data may be retrieved from a service bulletin database that is remote from the aircraft service bulletin analysis system. The processor(s) may be further configured to retrieve current cost information for implementing the one or more service bulletins from a service cost database that is remote from the aircraft service bulletin analysis system.

In at least one embodiment, the system may include at least one aircraft data unit that is configured to retrieve the aircraft data. In at least one embodiment, the system may include a service bulletin unit configured to retrieve the service bulletin data and/or form the aggregated aircraft data file. In at least one embodiment, the system may include an economic analysis unit configured to generate the economic analysis.

In at least one embodiment, the processor(s) may be further configured to prompt a user to provide a project name, select an airline provider, select an aircraft model from a fleet of the airline provider, select a relevant analysis time period, and initiate a project after the project has been named, after the airline provider, aircraft model, and relevant analysis time period have been selected. The processor(s) may be further configured to prompt the user to select one or more aircraft of the project, and select the one or more service bulletins associated with the selected aircraft of the project.

In at least one embodiment, the processor(s) are configured to generate the economic analysis by generating potential service bulletin information that indicates potential costs and benefits of implementing the service bulletins over a selected or otherwise defined time period.

Certain embodiments of the present disclosure provide an aircraft service bulletin analysis method that may include using a communication device to retrieve aircraft data and service bulletin data, automatically forming an aggregated aircraft data file that includes the aircraft data and the service bulletin data, and automatically generating an economic analysis based on one or more aircraft and implementation of one or more service bulletins associated with the one or more aircraft selected by a user.

### BRIEF DESCRIPTION OF THE DRAWINGS

FIG. 1 illustrates a block diagram of an aircraft service bulletin analysis system, according to an embodiment of the present disclosure.

FIG. 2 is a diagrammatic representation of a display of an aircraft service bulletin analysis system, according to an embodiment of the present disclosure.

FIG. 3 is a diagrammatic representation of a display of an aircraft service bulletin analysis system showing a project summary screen, according to an embodiment of the present disclosure.

FIG. 4 is a diagrammatic representation of a display of an aircraft service bulletin analysis system showing a list of aircraft selected for a project, according to an embodiment of the present disclosure.

FIG. 5 is a diagrammatic representation of a display of an aircraft service bulletin analysis system showing a delay information screen for selected aircraft, according to an embodiment of the present disclosure.

FIG. 6 is a diagrammatic representation of a display of an aircraft service bulletin analysis system showing a potential service bulletin screen for selected aircraft, according to an embodiment of the present disclosure.

FIG. 7 is a diagrammatic representation of a display of an aircraft service bulletin analysis system showing an economically beneficial service bulletin screen, according to an embodiment of the present disclosure.

FIG. 8 illustrates a flow chart of a method of generating an aggregated aircraft data file, according to an embodiment of the present disclosure.

FIG. 9 illustrates a flow chart of a method of providing a service bulletin analysis, according to an embodiment of the present disclosure.

FIG. 10 is a diagrammatic representation of a perspective top view of an aircraft, according to an embodiment of the present disclosure.

FIG. 11 illustrates a schematic block diagram of an aircraft, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide an aircraft service bulletin analysis system that is configured to retrieve multiple service bulletins related to aircraft, such as those of one or more providers. The system is further configured to screen the service bulletins in order to disregard service bulletins that may be irrelevant to a particular project. The system is further configured to extract pertinent information from selected service bulletins and compare the selected service bulletins to particular issues related to the aircraft. The system is further configured to organize information regarding the selected service bulletins and perform an economic analysis that may be used to make an educated decision regarding implementation of the selected service bulletins. The system may also generate data, such as in the form of graphs, charts, and the like, to be included in a report that is delivered to an individual user.

Certain embodiments of the present disclosure provide an aircraft service bulletin analysis system and method that minimizes or otherwise reduces an amount of time to gather, organize, and process information regarding aircraft costs and benefits. The system and method allow a user to rapidly experiment with different combinations to develop well-supported economic business cases for a user, such as an employee or business-related department of an aircraft provider.

Certain embodiments of the present disclosure provide a system and method that aggregates aircraft provider and manufacturer data from various sources to determine whether implementation of non-mandatory service bulletins provide an economic benefit to a provider.

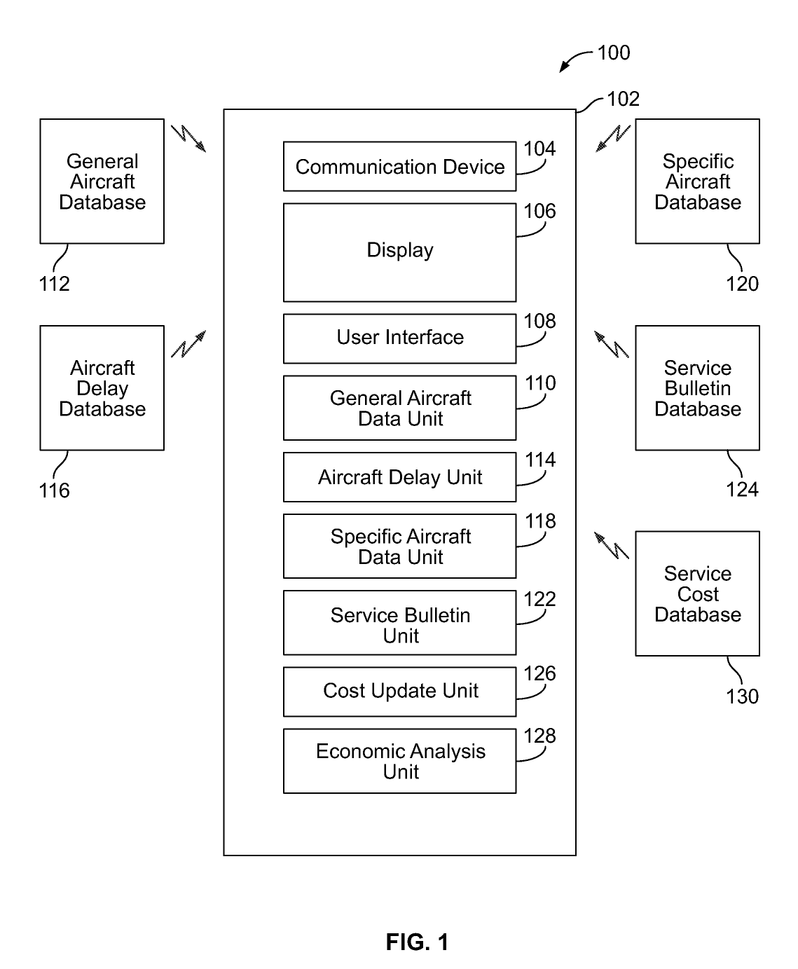

FIG. 1 illustrates a block diagram of an aircraft service bulletin analysis system 100, according to an embodiment of the present disclosure. The system 100 may include a housing 102 that may include a communication unit 104, a display 106, and a user interface 108. The housing 102 may be that of a personal computer, laptop computer, handheld device (such as a smart phone or tablet), and/or the like. Optionally, the housing 102 may be unique to the system 100, such as a unique handheld housing specifically designed for the system 100. The communication device 104 may be a device, such as a modem, antenna, broadband connection, transceiver, and/or the like, that is configured to allow the system 100 to communicate with one or more databases, servers, systems, and/or the like, such as through the internet, radio frequency communications, wired or wireless connections, and/or the like. Optionally, the system 100 may not include the communication device 104, the display 106, and/or the user interface 108, but may instead be or include hardware, software, firmware, and/or the like that is configured to operatively couple to a another computing system, such as a personal computer, laptop computer, smart device, and/or the like.

The display 106 may be or otherwise include a monitor or television, for example. In at least one embodiment, the display 106 may include a plasma, liquid crystal display, light emitting diode, or the like screen. The display 106 is configured to present information to a user and allow the user to interact with the system 100.

The user interface 108 is configured to allow a user to interact with the system, such as through input commands. The user interface 108 may be or include a keyboard, mouse, touchscreen (which may be integrated with the display 106), touchpad, and/or the like.

The system 100 may include a general aircraft data unit 110 that is configured to retrieve general information regarding a fleet of aircraft. For example, the system 100 may be in communication with a general aircraft database 112 through the communication device 104. The general aircraft database 112 may be separate, distinct, and remote from the system 100. For example, the general aircraft database 112 may be at a separate geographic location than the system 100. In short, the general aircraft database 112 may not be part of the system 100. The general aircraft database 112 may include general aircraft data files regarding general information regarding the fleet of aircraft. For example, the general aircraft database 112 may include a general aircraft data file related to every aircraft delivered from an aircraft manufacturer (such as the Boeing Company) to an airline provider (such as XYZ Airlines). In at least one embodiment, the general aircraft data file may include a serial number, configuration, owner, and provider/operator for each aircraft within an aircraft fleet. The general aircraft data unit 110 may be configured to retrieve the general aircraft data file from the general aircraft database 112 through the communication device 104. A user may select a particular aircraft fleet and retrieve the general aircraft data file associated with the particular fleet. For example, a user may select a general aircraft data file for a particular aircraft model (such as a Boeing 737) owned by a particular provider (such as XYZ Airlines).

In at least one embodiment, the user may not select or directly access the general aircraft data file. Instead, after a user makes particular selections, the system 100 may retrieve the general aircraft data file and various other files to form an aggregated aircraft data file.

The system 100 may include an aircraft delay unit 114 that is configured to retrieve aircraft delay information (for example, an aircraft delay data file) regarding the aircraft within a fleet. For example, the system 100 may be in communication with an aircraft delay database 116 through the communication device 104. The aircraft delay database 116 may be separate, distinct, and remote from the system 100 and the general aircraft database 112. The aircraft delay database 116 may include an aircraft delay file related to one or more aircraft fleets. The aircraft delay file may be or include a compilation of aircraft delays for multiple fleets of aircraft. The aircraft delay information within the aircraft delay file may include delay occurrences, reasons for delays, and costs associated with the delays. For example, for each aircraft delay, something may have gone wrong with a particular aircraft, such as a mechanical, electrical, or other such failure with a particular system or subsystem of an aircraft.

The aircraft delay unit 114 may correlate the selected general aircraft data file retrieved by the general aircraft data unit with the aircraft delay file for the aircraft included in the selected general aircraft data file. Thus, for each aircraft listed in the selected general aircraft data file, the aircraft delay unit 114 may add or otherwise associate aircraft delay information included in the aircraft delay data file.

In at least one embodiment, for a particular aircraft fleet, a user may select an aircraft model (such as Boeing 737s) and the aircraft delay file for such selected aircraft model. Then aircraft delay unit 114 may associate the aircraft delay file for the selected aircraft models, and remove any other non-selected aircraft models.

In at least one embodiment, the user may not select or directly access the aircraft delay file. Instead, after a user makes particular selections, the system 100 may retrieve the aircraft delay file and various other files to form an aggregated aircraft data file.

The system 100 may include a specific aircraft data unit 118 that is configured to retrieve specific information regarding the selected fleet of aircraft. For example, the system 100 may be in communication with a specific aircraft database 120, such as an airplane configuration tracking database, through the communication device 104. The specific aircraft database 120 may be separate, distinct, and remote from the system 100, the general aircraft database 112 and the aircraft delay database 116. The specific aircraft database 120 may include specific aircraft data files regarding specific information regarding the fleet of aircraft. The specific aircraft data files may include additional information for each aircraft within a fleet. For example, the specific aircraft data files may include an effectivity number, which may be a specific number used to identify an aircraft. The effectivity number may be or include a specific identification number that an aircraft manufacturer or provider uses internally to identify an aircraft. For example, an aircraft manufacturer may provide service bulletins that identify aircraft through effectivity numbers, instead of general serial numbers listed in the general aircraft data files. The specific aircraft data unit 118 may then associate the specific aircraft data files for an aircraft fleet selected through the association of the general aircraft data file and the aircraft delay file. In this manner, the specific aircraft data unit may be used to correlate specific aircraft information with general aircraft information and associated aircraft delay information.

The system 100 may include a service bulletin unit 122 that is configured to retrieve service bulletin data. For example, the system 100 may be in communication with a service bulletin database 124 through the communication device 104. The service bulletin database 124 may be separate, distinct, and remote from the system 100, the general aircraft database 112, the aircraft delay database 116, and the specific aircraft database 120. The service bulletin database 124 may include service bulletin information for each aircraft within a fleet. The service bulletin unit 122 retrieves the service bulletin information for each aircraft included in an aggregated aircraft data file, which may include the general aircraft data file, the aircraft delay file, and the specific aircraft data file. As such, the service bulletin database 124 may associate service bulletin information for each aircraft within the aggregated aircraft data file.

In at least one embodiment, the service bulletin unit 122 may remove service bulletin information related to service bulletins that are mandatory and/or non-mandatory service bulletins that have already been implemented. In short, there is no need to perform an economic analysis for service bulletins that are required to be implemented, and/or for those that have already been implemented.

The system 100 may include a cost update unit 126 that is configured to retrieve current cost information for particular service bulletins. For example, the system 100 may be in communication with a service cost database 130 through the communication device 104. The service cost database 130 may be separate, distinct, and remote from the system 100, the general aircraft database 112, the aircraft delay database 116, the specific aircraft database 120, and the service bulletin database 124. The cost update unit 126 may be configured to retrieve current cost information for each service bulletin listed in the aggregated aircraft data file. For example, service bulletins within the aggregated aircraft data file may be relatively old (for example, 2 or 3 years old), and costs (such as costs of parts used in to implement the service bulletin) may have changed since the service bulletins were initially generated. The cost update unit 126 may retrieve current costs for each service bulletin and updates them accordingly.

The system 100 may include an economic analysis unit 128 that is configured to provide an economic analysis for the service bulletins listed in the aggregated aircraft data file. For example, the economic analysis unit 128 may analyze the cost of one or multiple service bulletins selected by a user and determine whether the benefits of the service bulletin(s) outweigh the costs over a selected or otherwise defined time frame. The economic analysis unit 128 may also generate charts, graphs, or other such graphics that display the economic analysis in a easy to understood format.

As shown, the system 100 may include one or more units configured to perform various tasks. The units may be separate and distinct from one another. For example, the units may be in communication with one another through one or more wired or wireless connections. In at least one embodiment, the units may be part of a single integrated chip. In at least one other embodiment, the units may be part of multiple integrated chips. Also, alternatively, all of the units may be part of a single central processing or control unit that is configured to perform the functions associated with each unit. Also, alternatively, the system 100 may not include all of the specific units shown. For example, the system 100 may not include the specific aircraft data unit 118, the cost update unit 126, and/or the like.

In operation, the system 100 may first generate the aggregated aircraft data file, which aggregates and organizes data from multiple separate and distinct data sources. For example, the system 100 may retrieve the general aircraft data file from the general aircraft database 112, the aircraft delay file from the aircraft delay database 116, the specific aircraft data file from the specific aircraft database 120, the service bulletin data file or information from the service bulletin database 124, and the current cost information from the service cost database 130. The system 100, through one or more of the units shown, retrieves all of the data from the specific databases and may associate the data together to form the aggregated aircraft data file. Optionally, the system 100 may retrieve all of the data from the separate and distinct sources, but may not necessarily associate it into a single data file. That is, the complied aircraft data file may be or include multiple data files collected together. As explained below, the user may then select specific aircraft within a fleet, and view and select specific service bulletins associated therewith. Optionally, the user may make particular selections, and the system 100 may retrieve data from multiple sources based on the selections. The system 100 may then perform an economic analysis with respect to the selected service bulletins for the selected aircraft and provide an economic cost benefit analysis report to be delivered to a provider (such as XYZ Airlines).

The system 100 may retrieve data from multiple sources, such as the databases shown in FIG. 1. After or as the data is retrieved, the system may generate an aggregated aircraft data file. After or as the aggregated aircraft data file is generated, a user (such as an employee of an aircraft manufacturer, such as The Boeing Company) may then interact with the system 100, through the display 106 and the user interface 108, to select particular aircraft and particular service bulletins associated with the selected aircraft. In response to the user selecting particular service bulletins for selected aircraft, the system 100 may then perform an economic analysis with respect to the selected service bulletins. The system 100 may generate an economic analysis report that may be delivered or otherwise sent to a provider (such as XYZ Airlines).

The system 100 may include one or more processors configured to perform the functions described in the present application. For example, in at least one embodiment, each of the units 110, 114, 118, 122, 126, and 128 may be or include a separate and distinct processor and memory configured to perform the respective operations described above. In at least one other embodiment, a single processor or multiple processors may be configured to perform the operations described in the present application.

The units 110, 114, 118, 122, 126, and 128 may be contained within a housing that may be or otherwise include one or more computing devices, such as standard computer hardware (for example, processors, circuitry, memory, and the like). The units 110, 114, 118, 122, 126, and 128 may each or collectively include one or more control units, circuits, or the like, such as processing devices that may include one or more microprocessors, microcontrollers, integrated circuits, memory, such as read-only and/or random access memory, and the like. As an example, each of the units 110, 114, 118, 122, 126, and 128 may include or be formed as an integrated chip. Each of the units 110, 114, 118, 122, 126, and 128 may be separate and distinct circuits or processors within the system 100, for example. Optionally, the units 110, 114, 118, 122, 126, and 128 may be integrated into a single circuit or processor.

As used herein, the term “controller,” “control unit,” “unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor capable of executing the functions described herein. Such are exemplary only, and are thus not intended to limit in any way the definition and/or meaning of such terms.

The units 110, 114, 118, 122, 126, and 128 execute a set of instructions that are stored in one or more storage elements (such as one or more memories), in order to process data. For example, the units 110, 114, 118, 122, 126, and 128 may include one or more memories. The storage elements may also store data or other information as desired or needed. The storage element may be in the form of an information source or a physical memory element within a processing machine.

The set of instructions may include various commands that instruct the units 110, 114, 118, 122, 126, and 128 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units. It is to be understood that the processing or control units may represent circuit modules that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control units may represent processing circuitry such as one or more of a field programmable gate array (FPGA), application specific integrated circuit (ASIC), microprocessor(s), a quantum computing device, and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

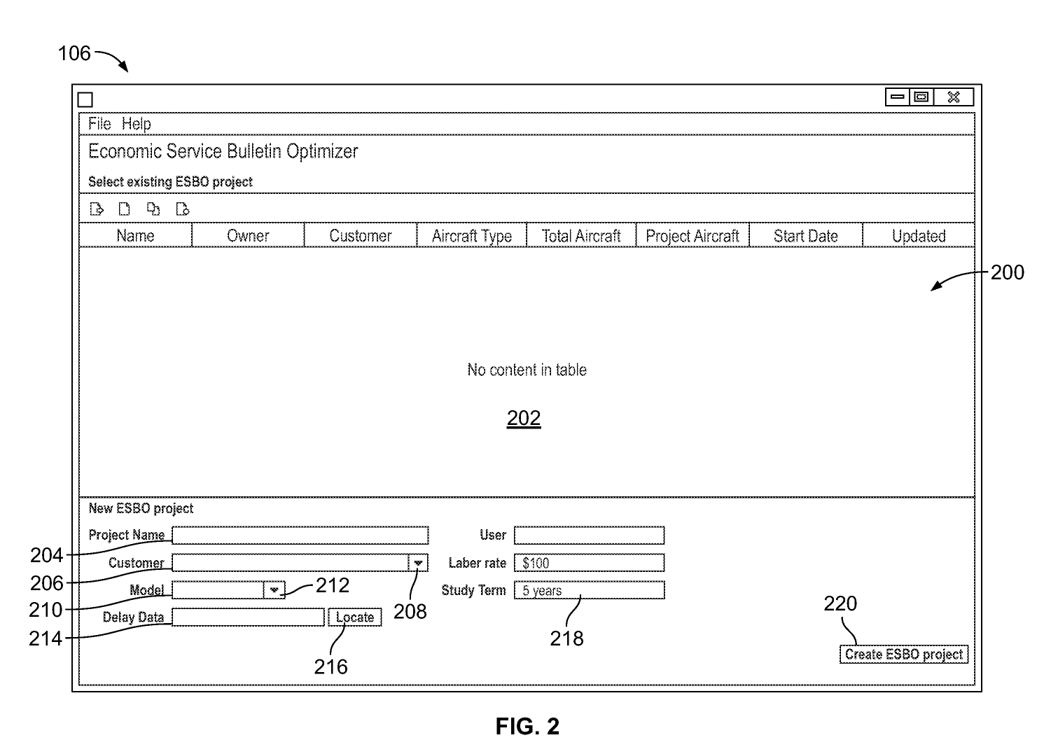

FIG. 2 is a diagrammatic representation of the display 106 of the aircraft service bulletin analysis system 100 (shown in FIG. 1), according to an embodiment of the present disclosure. As shown in FIG. 2, the display 106 provides a screen shot 200 at an initial stage before a user selects information regarding service bulletins for aircraft. To begin, the user first selects an existing project (an Economic Service Bulletin Optimizer—“ESBO”—project). The initial screen shot 200 includes a field 202, which is empty as the user has yet to make any selections.

The user may enter a project name in a project name field 204 and select a particular customer (for example, a provider such as XYZ Airlines) from a customer selection field 206. The customer selection field 206 may include a drop down selection button 208, which, when engaged (such as through use of a computer mouse, touch on a touchscreen, and/or the like), lists a number of customers.

The user may also enter an aircraft model from a model field 210, which may include a drop down selection button 212. For example, the user may select a particular aircraft model, such as a Boeing 737, from the model field 210.

The user may then locate delay data within the delay data field 214. By engaging a locate button 216, the user may locate aircraft delay data that has been retrieved from the aircraft delay database 116. Optionally, when the locate button 216 is engaged, the system 100 may retrieve the aircraft delay data. The located aircraft delay data may be correlated or otherwise associated with customer and model selected by the user.

The user may then input a relevant time period in a study term field 218. For example, as shown in FIG. 2, the user has selected a relevant time period of 5 years.

After the user has selected the customer and model, located delay data, and indicated a relevant time period, the user then engages a project create button 220. In response to the project create button 220 being engaged, the aircraft service bulletin analysis system 100 may generate an aggregated aircraft data file based on the noted user selections.

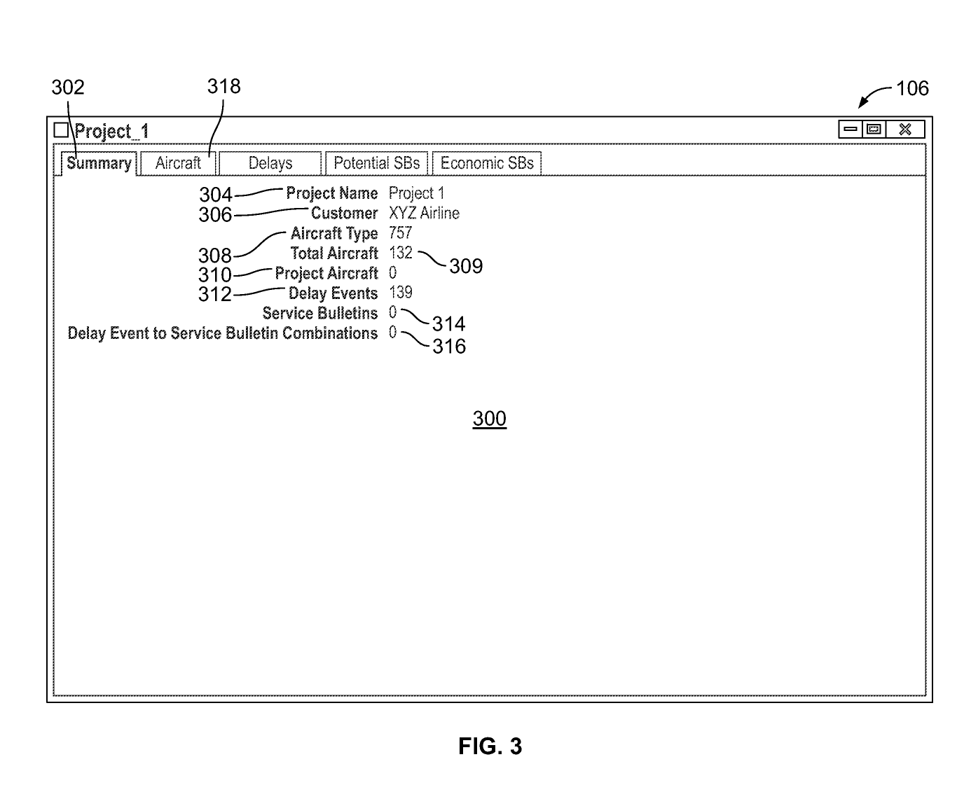

FIG. 3 is a diagrammatic representation of the display 106 of the aircraft service bulletin analysis system 100 (shown in FIG. 1) showing a project summary screen 300, according to an embodiment of the present disclosure. The project summary screen 300 appears in response to the user making the selections noted above with respect to FIG. 2, and engaging the project create button 220.

The project summary screen 300 is shown in response to a user engaging a summary tab 302. As shown, the project summary screen 300 may include a project name 304, a customer 306, an aircraft type 308, total aircraft 309, selected aircraft from fleet (that is, project aircraft selected from total aircraft) 310, delay events 312, and selected service bulletins 314. The summary screen 300 may also include a selected delay event-to-service bulletin combinations 316. A delay event-to-service bulletin combination is a combination of a delay events (for example, events that causes a flight delay) and a service bulletin associated with rectifying such a delay event. As shown in FIG. 3, no aircraft are currently selected in the selected aircraft from fleet 310. Further, no service bulletins are currently selected in the selected service bulletins 314, and no delay event-to-service bulleting combinations are currently selected in the combinations 316.

As shown, the project 304 has been identified as Project 1. The customer 306 is XYZ Airlines. The aircraft type 308 selected by the user is a Boeing 757. As such, the aggregated aircraft data file includes all Boeing 757s owned by XYZ Airlines). The total aircraft 309 of Boeing 757s owned by XYZ Airlines is shown to be 132 aircraft. Thus, the aggregated aircraft data file includes information regarding 132 Boeing 757s owned by XYZ Airlines. As also shown in FIG. 3, the user has not yet selected any of the 132 aircraft to be included in Project 1 (thus, the project aircraft 310 is shown as 0), nor has the user yet selected any service bulletins associated with the 132 aircraft (thus, the service bulletins 314 is shown as 0). However, 139 delay events 312 have been identified with the 132 aircraft. In order to select particular aircraft for analysis within the group of 132 aircraft, the user engages an aircraft tab 318 shown on the display 106.

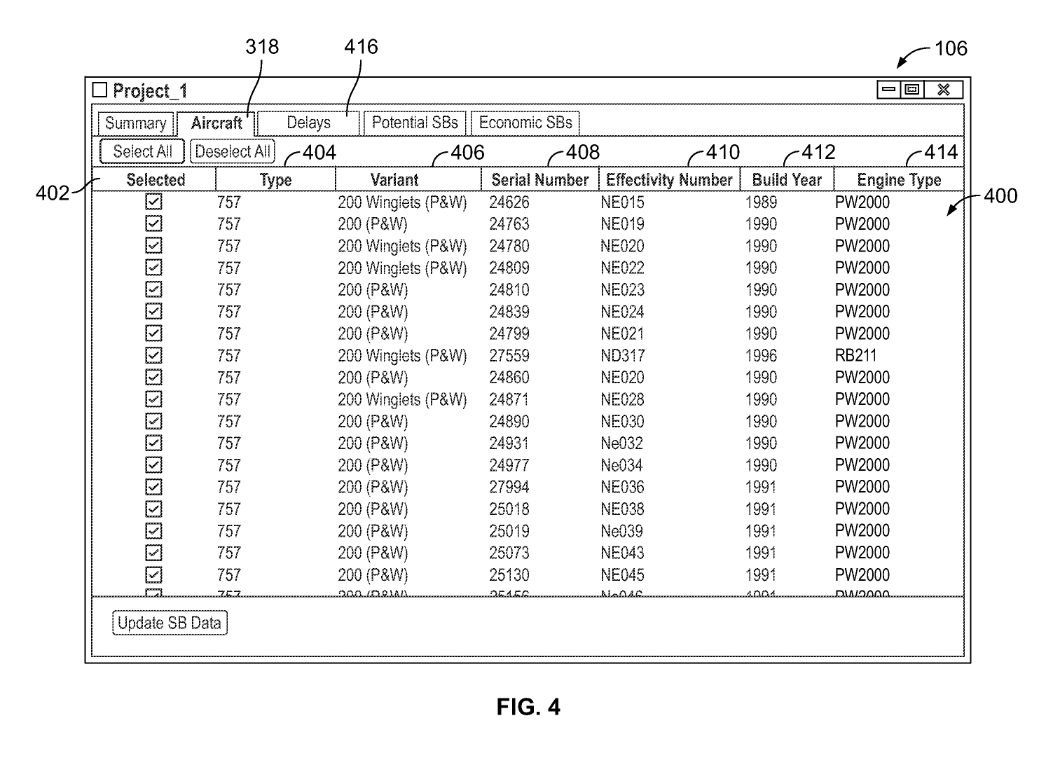

FIG. 4 is a diagrammatic representation of the display 106 of the aircraft service bulletin analysis system 100 (shown in FIG. 1) showing a list of aircraft selected for a project, according to an embodiment of the present disclosure. The display 106 shows an aircraft selection screen 400 that may include a selection area 402, an aircraft type 404, a variant 406, a serial number 408, an effectivity number 410, a build year 412, an engine type 414. The selection area 402 allows a user to select and deselect particular aircraft to be included within the project. The type 404 indicates the type of aircraft selected. The variant 406 indicates a particular variation of the aircraft type. The effectivity number 410 is a specific identification number for the aircraft, as noted above.

As shown in FIG. 4, a user may select particular aircraft to be included within the project, based on variation of aircraft type, serial number, effectivity number, build year, and/or engine type. As one example, a user may decide to include only aircraft built before 1991 in the project. As such, the user would de-select any aircraft having a build year before 1991. As shown in FIG. 4, all of the aircraft are selected. After the user has selected the aircraft for the project, the user may then engage the delays tab 416 in order to view the aircraft delays for the selected aircraft.

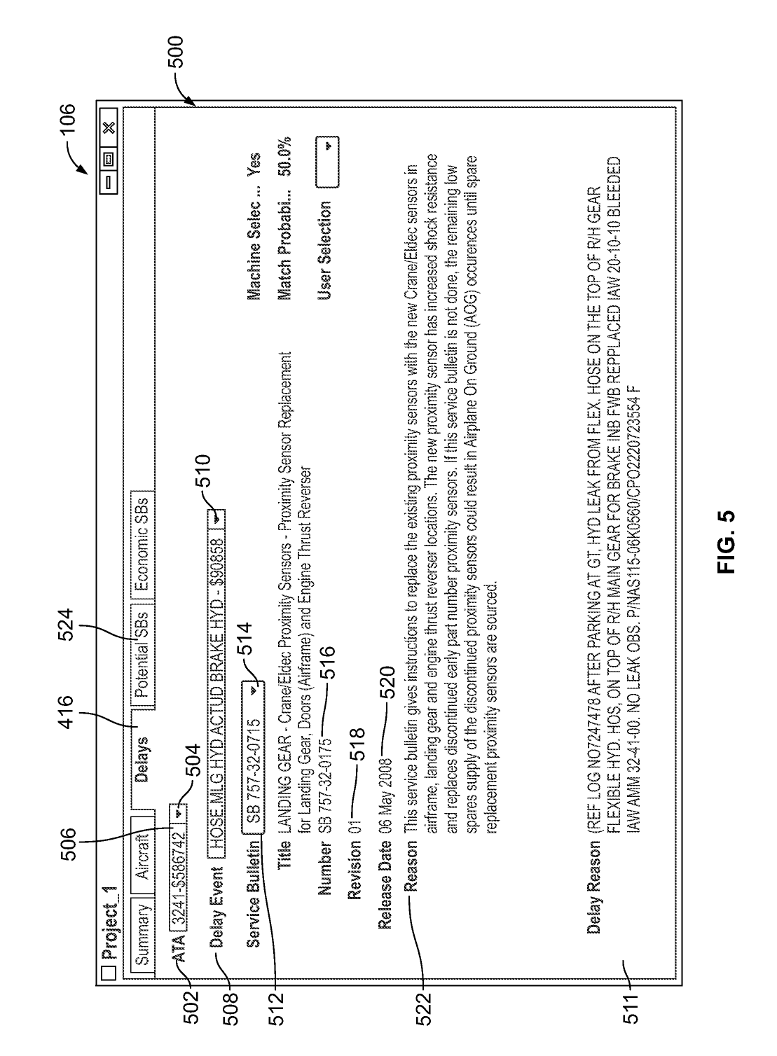

FIG. 5 is a diagrammatic representation of the display 106 of the aircraft service bulletin analysis system 100 showing a delay information screen 500 for selected aircraft, according to an embodiment of the present disclosure. The delay information screen 500 may include an ATA field 502. An ATA is a code that describes an aircraft system or subsystem. The ATA (“Air Transport Association”) code represents a common referencing standard for all commercial aircraft documentation. The ATA may include a four number code. The first two numbers may denote a particular system, while the second two numbers may denote a particular sub-system of the system. For example, the number 32 may indicate a landing gear system, while the number 41 may indicate a brake sub-system of the landing gear system. The user may select various ATAs through a drop down button 504. Once selected, the ATA field 502 shows the particular ATA selected, along with a total cost 506 for all delay events associated with the selected ATA. As shown in FIG. 5, the total cost for all service bulletins associated with ATA 3241 for the selected aircraft is $586,742.

The delay information screen 500 also includes a delay event selection field 508 having a drop down button 510 that allows the user to select and view a particular delay event that forms a part of the total cost 506. For example, as shown in FIG. 5, the user has selected a delay event pertaining to a hose of a hydraulic brake. The cost of the selected delay event, as shown in FIG. 5, is $90,858, which forms part of the total cost 506 shown. The delay information screen 500 may also show a delay reason 511 that summarizes the delay.

One or more service bulletins may be associated with the selected delay event. That is, one or more service bulletins may be generated that are configured to remedy the selected event. Accordingly, the delay information screen 500 may also include a service bulletin selection field 512 having a drop down button 514 that allows the user to select and view a particular service bulletin that is configured to remedy at least a portion of the selected delay event. As shown in FIG. 5, the user has selected a service bulletin entitled “LANDING GEAR.” The service bulletin may be identified by number 516, revision 518, release date 520, and reason 522. As shown in FIG. 5, the selected service bulletin provides instructions for replacing proximity sensors. The user may select and/or otherwise revise the service bulletins associated with the delay event. The user may then engage a potential service bulletin tab 524. In response to the potential service bulletin tab 524 being engaged, the aircraft service bulletin analysis system 100 may generate a screen showing information regarding a cost/benefit analysis of implementing the various service bulletins.

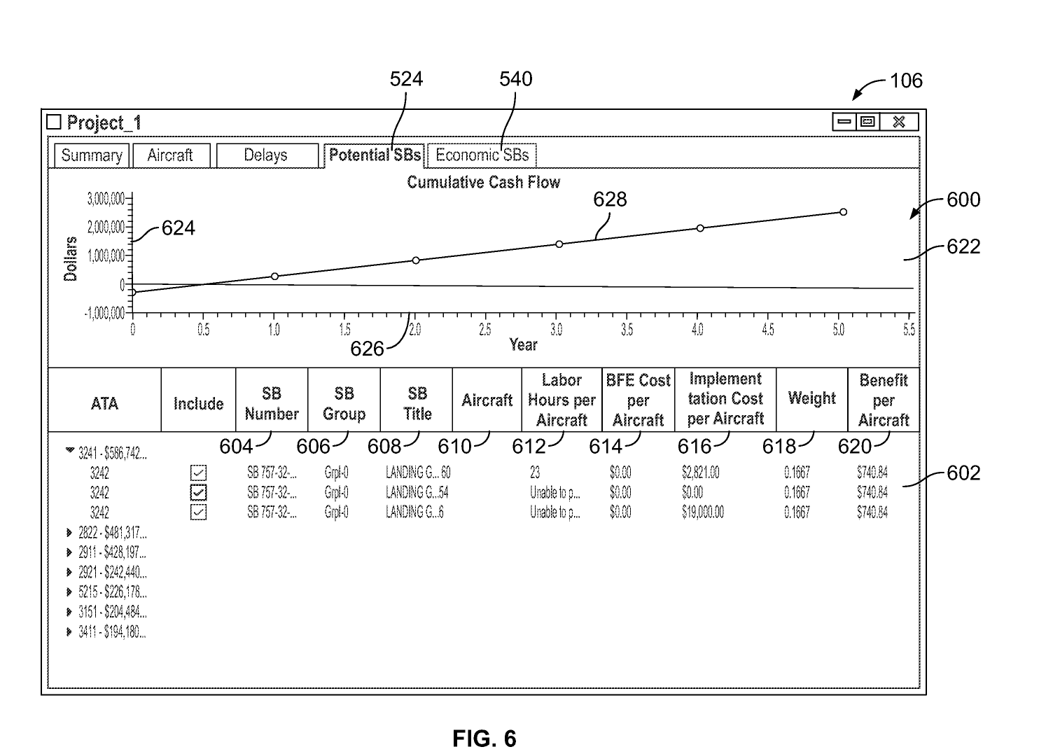

FIG. 6 is a diagrammatic representation of the display 106 of the aircraft service bulletin analysis system 100 (shown in FIG. 1) showing a potential service bulletin screen 600 for selected aircraft, according to an embodiment of the present disclosure. The potential service bulletin screen 600 includes a service bulletin selection field 602 that allows a user to select one or more service bulletins to be analyzed. Each service bulletin may be identified by number 604, group 606, title 608, number of applicable aircraft 610 (within the selected number of aircraft), labor hours necessary to implement 612, buyer furnished equipment cost 614, implementation cost 616, weight 618 (which may relate to a prediction as to whether the service bulletin will effectively remedy the delay), and benefit per aircraft 620.

In response to the user selecting one or more service bulletins, the aircraft service bulletin analysis system 100 generates an economic prediction within a prediction data field 622. For example, the economic analysis unit 128 shown in FIG. 1 may generate the economic prediction. As shown in FIG. 6, the economic prediction may include a graph indicating dollars saved 624 in relation to a time axis 626. The system 100 may show a cost benefit indicator 628, such as a line, curve, or the like, that illustrates the cost benefit of the selected service bulletins over the selected time period. The prediction data field 622 may provide various other types of graphics in addition to, or instead of, the graph shown. For example, the prediction data field 622 may show a pie chart, bar graph, and/or the like.

The user may select any of the listed service bulletins in the service bulletin selection field 602 to view more information on each. For example, the user may click on each service bulletin, which may then generate a window showing part kits for each service bulletin, the cost per kit, the number of available kits, and the like. The user may also engage a cost update button (not shown) to retrieve updated cost information for each service bulletin. The user may also update the weight 618 through a similar window. The user may update the weight 618 by inputting revised weight data.

The user may then engage an economic service bulletin tab 540 to review service bulletins that lead to cost savings over time. The economic analysis unit 128 shown in FIG. 1 may analyze the various service bulletins to determine which service bulletins provide an economic benefit over a selected time period.

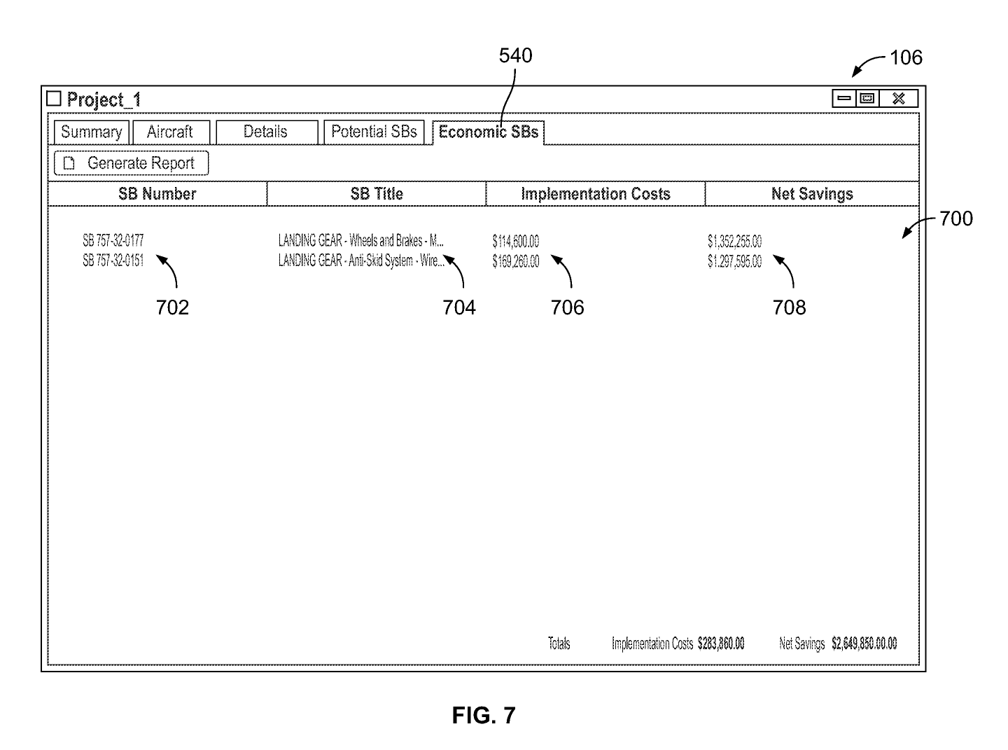

FIG. 7 is a diagrammatic representation of the display 106 of the aircraft service bulletin analysis system 100 (shown in FIG. 1) showing an economically beneficial service bulletin screen 700, according to an embodiment of the present disclosure. The economic analysis unit 128 may analyze the service bulletins selected by a user and output the economically beneficial service bulletin screen 700, which may list service bulletins 702, titles 704, implementation costs 706, and net savings 708. Notably, all of the selected service bulletins may be shown, even those that provide a net loss over a selected time period. In this manner, the system 100 aggregates data from multiple separate and distinct sources, and generates an economic analysis that a provider may use to determine which, if any, non-mandatory service bulletins to implement.

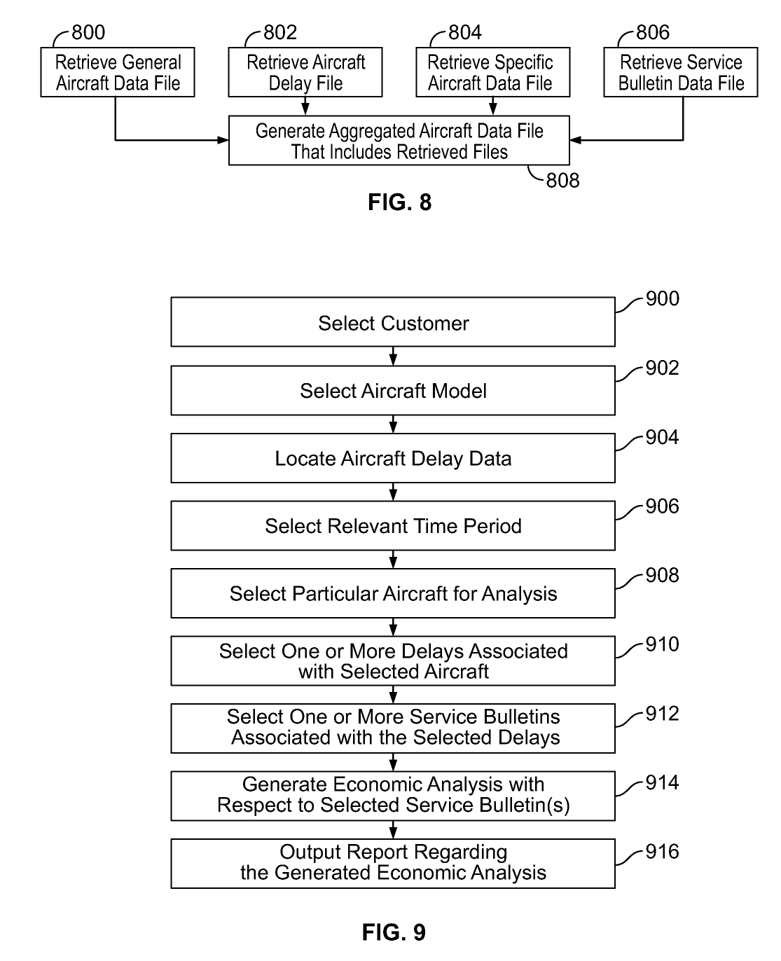

FIG. 8 illustrates a flow chart of a method of generating an aggregated aircraft data file, according to an embodiment of the present disclosure. At 800, a general aircraft data file is retrieved. For example, a general aircraft data unit may retrieve the general aircraft data file from a general aircraft database.

At 802, an aircraft delay file is retrieved. For example, an aircraft delay unit may retrieve the aircraft delay file from an aircraft delay database.

At 804, a specific aircraft data file may be retrieved. For example, a specific aircraft data unit may retrieve the specific aircraft delay file from a specific aircraft data base.

At 806, a service bulletin data file is retrieved. For example, a service bulletin unit may retrieve the service bulletin data file from a service bulletin data base.

At 808, the retrieved files are used to generate an aggregated aircraft data file. For example, at least one processor within an aircraft service bulletin analysis system may organize the retrieved data and form the aggregated aircraft data file. In at least one embodiment, an economic analysis unit (such as the economic analysis unit 128 shown in FIG. 1) may generate the aggregated aircraft data file. After or as the various data files are retrieved, organized, and/or aggregated, a user may interact with the system to select aircraft and service bulletins that may be used to generate an economic analysis.

FIG. 9 illustrates a flow chart of a method of providing a service bulletin analysis, according to an embodiment of the present disclosure. At 900, a user selects a customer, such as an airline service provider (for example, XYZ Airlines).

At 902, the user selects a particular type of aircraft model for analysis. For example, the user may desire an economic analysis related to all Boeing 737s of XYZ Airlines.

At 904, aircraft delay data is located. In one embodiment, the aircraft delay data may be part of the aggregated aircraft delay data. In at least one other embodiment, after the user selects the customer and aircraft model, the aircraft service bulletin analysis system may then retrieve the aircraft delay data related to the selected aircraft from an aircraft delay database.

The user then selects a relevant time period at 906. In response to the initial user selections, a project summary screen may be generated. The user then selects particular aircraft from the larger set of customer and model selections at 908.

At 910, the user may then select one or more delays associated with the selected aircraft. Then, at 912, the user may select one or more service bulletins associated with the selected delay(s).

At 914, an economic analysis may be generated with respect to the selected service bulletin(s). For example, an economic analysis unit (such as the economic analysis unit 128 shown in FIG. 1) may generate the economic analysis. At 916, a report regarding the generated economic analysis is output. The report may be shown on a display to a user (such as the individual who selects the various criteria for the economic analysis). The report may then be sent to a provider, such as XYZ Airlines, through electronic mail, messaging, regular mail, or the like.

Thus, embodiments of the present disclosure provide systems and methods for efficiently organizing service bulletins for aircraft and analyzing information to quickly and accurately assess the economic costs and benefits of implementing service bulletins.

Components of the systems may include or represent hardware circuits or circuitry that include and/or are connected with one or more processors, such as one or more computer microprocessors. The operations of the methods described herein and the systems may be sufficiently complex such that the operations cannot be mentally performed by an average human being or a person of ordinary skill in the art within a commercially reasonable time period. For example, analyzing the numerous elements within hundred, thousands, or more service bulletins and assessing economic costs and benefits generally takes into account a large amount of factors, relies on relatively complex computations, and involves examination of many permutations of different potential sequences, and the like, such that such a person cannot complete the operations within a commercially reasonable time period to have the data ready for review. The hardware circuits and/or processors of service bulletin analysis systems may be used to significantly reduce the time needed to analyze data and generate economic reports such that they are generated within commercially reasonable time periods.

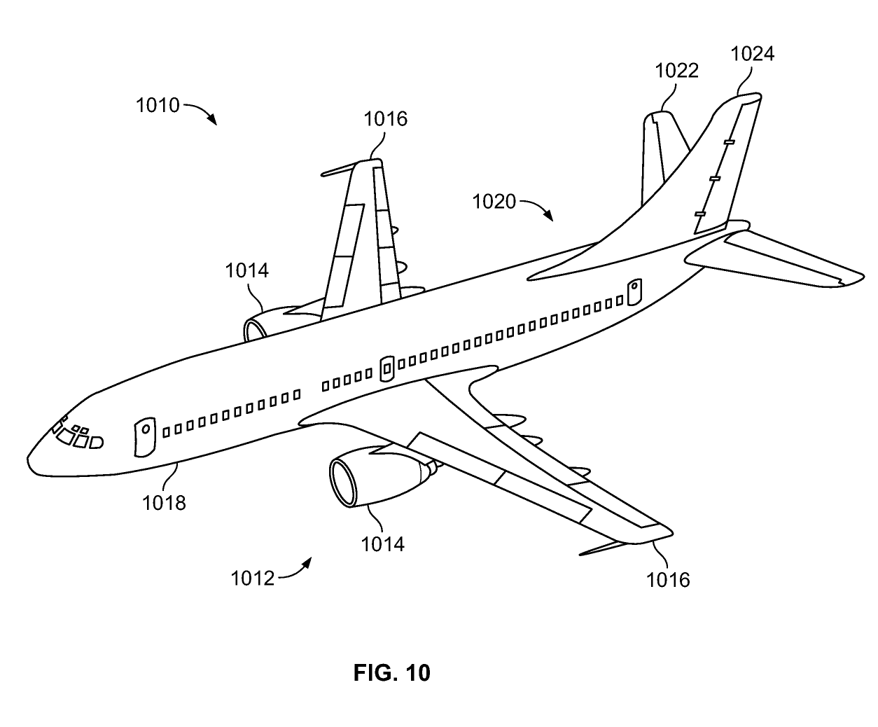

FIG. 10 is a diagrammatic representation of a perspective top view of an aircraft 1010 (or aircraft assembly), according to an embodiment of the present disclosure. The aircraft 1010 is an example of a vehicle that may include various systems and sub-systems that may be subject to one or more service bulletins. Alternatively, instead of an aircraft, the systems and methods of embodiments of the present disclosure may be used with various other vehicles, such as automobiles, buses, locomotives and train cars, watercraft, spacecraft, and the like.

The aircraft 1010 may include a propulsion system 1012 that may include two turbofan engines 1014, for example. Optionally, the propulsion system 1012 may include more engines 1014 than shown. The engines 1014 are carried by wings 1016 of the aircraft 1010. In other embodiments, the engines 1014 may be carried by a fuselage 1018 and/or an empennage 1020. The empennage 1020 may also support horizontal stabilizers 1022 and a vertical stabilizer 1024.

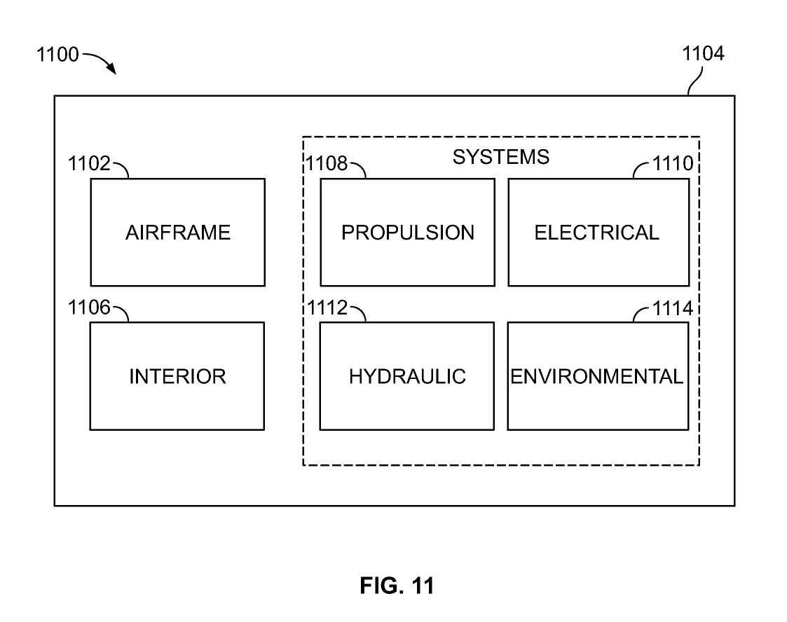

FIG. 11 illustrates a schematic block diagram of an aircraft 1100, according to an embodiment of the present disclosure. The aircraft 1100 is an example of a vehicle including a plurality of systems and sub-systems that may be subject to one or more service bulletins. The aircraft 1100 may include an airframe 1102 with a plurality of systems 1104 and an interior 1106. Examples of the systems 1104 include one or more of a propulsion system 1108, an electrical system 1110, a hydraulic system 1112, and an environmental system 1114. Any number of other systems may be included.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting; rather, they are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An aircraft service bulletin analysis system configured to provide an economic analysis of implementing one or more service bulletins regarding one or more aircraft, the aircraft service bulletin system comprising one or more processors configured to:
retrieve aircraft data and service bulletin data;
form an aggregated aircraft data file that includes the aircraft data and the service bulletin data; and
generate an economic analysis based on one or more aircraft and implementation of one or more service bulletins associated with the one or more aircraft selected by a user.

2. The aircraft service bulletin analysis system of claim 1, wherein the aircraft data comprises:
general aircraft data retrieved from a general aircraft database that is remote from the aircraft service bulletin analysis system; and
specific aircraft data retrieved from a specific aircraft database that is remote from the aircraft service bulletin analysis system.

3. The aircraft service bulletin analysis system of claim 1, wherein the service bulletin data is retrieved from a service bulletin database that is remote from the aircraft service bulletin analysis system.

4. The aircraft service bulletin analysis system of claim 1, wherein the one or more processors are further configured to retrieve current cost information for the one or more service bulletins from a service cost database that is remote from the aircraft service bulletin analysis system.

5. The aircraft service bulletin analysis system of claim 1, further comprising at least one aircraft data unit that is configured to retrieve the aircraft data.

6. The aircraft service bulletin analysis system of claim 1, further comprising a service bulletin unit configured to retrieve the service bulletin data or form the aggregated aircraft data file.

7. The aircraft service bulletin analysis system of claim 1, further comprising an economic analysis unit configured to generate the economic analysis.

8. The aircraft service bulletin analysis system of claim 1, wherein the one or more processors are further configured to prompt a user to:
provide a project name;
select an airline provider;
select an aircraft model from a fleet of the airline provider;
select a relevant analysis time period; and
initiate a project after the project has been named, and the airline provider, aircraft model, and relevant analysis time period have been selected.

9. The aircraft service bulletin analysis system of claim 8, wherein the one or more processors are further configured to prompt the user to:
select one or more aircraft of the project; and
select the one or more service bulletins associated with the selected aircraft of the project.

10. The aircraft service bulletin analysis system of claim 1, wherein the one or more processors are configured to generate the economic analysis by generating potential service bulletin information that indicates potential costs and benefits of implementing the one or more service bulletins over a time period.

11. An aircraft service bulletin analysis method comprising:
using a communication device to retrieve aircraft data and service bulletin data;
automatically forming an aggregated aircraft data file that includes the aircraft data and the service bulletin data; and
automatically generating an economic analysis based on one or more aircraft and implementation of one or more service bulletins associated with the one or more aircraft selected by a user.

12. The aircraft service bulletin analysis method of claim 11, wherein the using a communication device operation comprises:
retrieving general aircraft data from a general aircraft database that is remote from the aircraft service bulletin analysis system; and
retrieving specific aircraft data from a specific aircraft database.

13. The aircraft service bulletin analysis method of claim 11, wherein the using a communication device operation comprises retrieving the service bulletin data from a service bulletin database that is remote from the aircraft service bulletin analysis system.

14. The aircraft service bulletin analysis method of claim 11, wherein the using a communication device operation further comprises retrieving current cost information for implementing the one or more service bulletins from a service cost database that is remote from the aircraft service bulletin analysis system.

15. The aircraft service bulletin analysis method of claim 11, further comprising prompting a user to provide a project name, select an airline provider, select an aircraft model from a fleet of the airline provider, select a relevant analysis time period, and initiate a project after the project has been named, and the airline provider, aircraft model, and relevant analysis time period have been selected.

16. The aircraft service bulletin analysis method of claim 15, further comprising prompting a user to select one or more aircraft of the project, and select the one or more service bulletins associated with the selected aircraft of the project.

17. The aircraft service bulletin analysis method of claim 11, wherein the automatically generating an economic analysis operation comprises generating potential service bulletin information that indicates potential costs and benefits of implementing the one or more service bulletins over a time period.

18. An aircraft service bulletin analysis system configured to provide an economic analysis of implementing one or more service bulletins regarding one or more aircraft, the aircraft service bulletin system comprising one or more processors configured to:
retrieve general aircraft data from a general aircraft database that is remote from the aircraft service bulletin analysis system;
retrieve specific aircraft data from a specific aircraft database that is remote from the aircraft service bulletin analysis system;
retrieve service bulletin data from a service bulletin database that is remote from the aircraft service bulletin analysis system;
retrieve current cost information for implementing the one or more service bulletins from a service cost database that is remote from the aircraft service bulletin analysis system;
form a complied aircraft data file that includes the general aircraft data, the specific air data, the service bulletin data, and the current cost information;
prompt a user to provide a project name, select an airline provider, select an aircraft model from a fleet of the airline provider, select a relevant analysis time period, and initiate a project after the project has been named, and the airline provider, aircraft model, and relevant analysis time period have been selected;
prompt the user to select one or more aircraft of the project, and select the one or more service bulletins associated with the selected aircraft of the project; and
generate an economic analysis based on the one or more aircraft selected and implementation of the one or more service bulletins associated with the one or more aircraft selected.

19. The aircraft service bulletin analysis system of claim 18, further comprising:
at least one aircraft data unit that is configured to retrieve the general aircraft data and the specific aircraft data;
a service bulletin unit configured to one or both of retrieve the service bulletin data and form the aggregated aircraft data file; and
an economic analysis unit configured to generate the economic analysis.

20. The aircraft service bulletin analysis system of claim 18, wherein the one or more processors are configured to generate the economic analysis by generating potential service bulletin information that indicates potential costs and benefits of implementing the one or more service bulletins over a time period.
